(19) United States
(12) Patent Application Publication
(10) Pub. No.: US 2010/0281008 A1
(43) Pub. Date: Nov. 4, 2010

(54) Universal Tracking Agent System and Method

(75) Inventor: Mary S. Braunwarth, Waconia, MN (US)

Correspondence Address: NORTH OAKS PATENT AGENCY, 45 ISLAND ROAD, NORTH OAKS, MN, 55127, US

(73) Assignee: DIGITAL RIVER, INC., Eden Prairie, MN (US)

(21) Appl. No.: 12/770,334

(22) Filed: Apr. 29, 2010

Related U.S. Application Data
(60) Provisional application No. 61/173,820, filed on Apr. 29, 2009.

(51) Int. Cl. G06F 15/173; G06F 17/30

(52) U.S. Cl. 707/705; 709/224; 707/E17.009

(57) ABSTRACT

A universal tracking agent system and method are described. The system utilizes a single, universal tag on merchant web pages in a commerce system. The tag collects data for marketing tracking and analysis from a local computer (e.g., a cookie or session variable set on a user computer browser) when the web pages are accessed. The system to receive the data, along with tracking code to collect the data, is determined when the program code accesses a back end database containing records of the marketing providers to which the merchant site subscribes. Only those systems requiring data for a particular user access event receive a report, and each receives a report based on its own requirements. Any changes to providers may be made in the database rather than the web page, providing a very efficient method of changing providers or code without waiting for release schedules or requiring developer resources.

### RELATED APPLICATIONS

This application claims the benefit of U.S. Provisional Application No. 61/173,820 filed 29 Apr. 2009, entitled “Universal Tracking Agent,” which is incorporated herein by reference.

### FIELD OF THE INVENTION

The present disclosure relates to electronic commerce systems for use on the internet. More specifically, the present disclosure relates to tools for collecting data on internet visits to web sites.

### BACKGROUND OF THE INVENTION

Internet merchants use a wide variety of tools and marketing programs to enhance a user's experience on their sites and drive incremental revenue. E-mail marketing, affiliate marketing, paid search and display advertising are just examples of the many third-party solutions available to merchants. In order to get the most for their money, merchants use tracking and optimization solutions, such as web analytics and site optimization that are generally part of their ecommerce provider's system, to determine which solutions give them the greatest return on their investment. Merchants use tracking code (typically in a pixel form) to track the behaviors of prospects and customers by each of the programs they are running. These solutions are highly dependent upon the collection of behavioral data of users on the internet.

A number of tracking technologies, including web logs, web beacons, javascript tags and packet sniffing have been used to collect data as a user navigates a merchant's web site. Web logs were originally developed to capture errors on web servers, but were eventually enhanced to capture behavioral data as well. All web servers have web log mechanisms, so collecting data using web logs is a simple and inexpensive solution. In addition, web logs easily capture and store visits and behavior of search engine crawlers, such as those belonging to Google and Yahoo, which read and index the pages of a web site. Many merchants desire this type of data in order to ensure that their sites are easily and accurately located when an internet user searches on key terms associated with the site.

There are many log file parsers available so obtaining data is easy and inexpensive. Web logs capture all hits on a server, so filtering is also required in order to extract useful information. While web logs are very efficient at capturing technical data, they are not particularly useful in capturing marketing data.

Web beacons were developed to facilitate the capture of marketing data, particularly information regarding who was coming to the web site and where they were coming from. Web beacons are usually a 1×1 pixel image embedded in web pages within an img src HTML tag. The pixels are generally hosted by a third-party service provider, such as a web analytics provider, affiliate marketing system, or email marketing system. In a typical web beacon scenario, when a user enters a URL in a browser or clicks on a banner ad, the request is sent to the web server, which sends back the page along with a request for a pixel image from the third-party server. As the page loads, it executes the call for the pixel image sending data about the page view back to the third-party server. The server sends the image back to the browser along with code that can read data from a local computer (e.g., a cookie or session variable set on a user computer browser) and capture anonymous visitor data, such as date and time of viewing, pages viewed, IP address of the browser, the referring source, and more.

Web beacons are easy to implement because they consist of a couple of lines of code wrapped around an img src HTML tag request. An added benefit is that data may be collected across multiple websites. For example, web beacons may capture data in an affiliate marketing system, where a user is tracked entering a site from an ad on an affiliate site. Web beacons are also well-suited for tracking email marketing campaign open and view rates. However, the data captured by web beacons is not as rich as that that may be collected using JavaScript tags.

JavaScript tags work in a similar manner to web beacons, but allow for more data to be collected more accurately. With JavaScript tags, a user enters the URL into a browser, and the request for the web page is sent to the web server. The web server sends back the page along with a snippet of JavaScript code appended to the page. As the page loads, it executes the JavaScript code, which captures the page view, details about the visitor session and other data from a local computer (e.g., a cookie or session variable set on a user computer browser), and sends it back to the data collection server. The server may send back additional code to the browser to set additional cookies or session variables or collect more data.

Finally, packet sniffing is a technology used to monitor and troubleshoot network traffic passing through a particular subnet interface. For example, a user types a URL into a browser. The request is routed to a web server, but before it gets there, it passes through a software or hardware-based packet sniffer that collects attributes of the request that can provide more information about the user. The packet sniffer sends the request to the web server, which sends the page back to the user, but is first passed to the packet sniffer, which captures and stores information about the page going back. JavaScript tags may be appended to the page that will provide even more data about the user.

As would be apparent to one skilled in the art, packet sniffing could be easily abused. Used with malicious intent, packet sniffing may collect such data as user names and passwords, addresses and credit card numbers. An internet merchant would not want to capture and store this information for the sake of customer privacy. However, the technology may be very useful if used properly.

Recent uses of tracking technology have generally involved placing individualized tags or pixels on each page for each solution provider. This can be challenging due to resource constraints and other priorities in the production queue, slowing the speed to market for new marketing programs or changes to existing marketing providers. In addition, tags, in production, can be overwritten and tracking/reporting is lost from the date of the overwrite.

The more marketing solutions an internet merchant subscribes to, the more unwieldy the application of tracking technology may get. Multiple tags running on pages impacts the fitness of pages and consumer experience. For example, a web page with, say ten solutions (e.g. email tracking, paid search, web analytics, optimization, etc.) would require the installation of ten tags or pixels. This would not only slow down the time it took to serve the page to the user, but the user may be off the page before the last of the tags fires, leaving at least some solutions with no data.

There have been some suggestions in the prior art for a universal tag that could be used by all solution providers, however, they are not without issues. One suggestion is a universal tag that is associated via database records with at least one third-party reporting pixel. When fired, the universal tag sends a report to each of the third-party systems to which it is associated. Another suggestion is the use of a universal tag that forces all providers to accept an identical report with identical data. Neither of these suggestions provides individualized data required for a particular solution only when that solution requires data. The present disclosure provides a solution to these needs and other problems, and offers other advantages over the prior art.

### BRIEF SUMMARY

The present disclosure relates to the collection of browser behavior data on the internet. A universal tracking agent system and method is a JavaScript-based technology, at the commerce level, that consists of one tag to be placed on the page, a “sniffer” agent or program code which determines which of a plurality of marketing tools to which a web merchant subscribes require tracking data, and a database to render the tracking necessary for each of the marketing tools or solutions. The universal tracking agent allows clients to launch programs immediately without having to wait for the production release queue. It further allows the capability to change providers at any time without having to execute new tagging and code at the production level. Rather, all updating is done in the backend tagging database.

In a preferred embodiment of a universal tracking agent system and method, the site is tagged with a universal tag. A record created in a tracking database for each marketing solution to which the website subscribes. A cookie or session variable is set on the user's browser when the pages are served to the user in response to click behavior. When the tag is activated, an intelligent “sniffer,” or universal tracking agent (UTA), the program code of which is hosted in the tracking database, reads the data from a local computer (e.g., a cookie or session variable set on a user computer browser). The tracking engine accesses the database to determine which solution providers should receive the data. The tracking code is pulled from the database and executed, appending data collected from the tracking code to any data requirements on the cookie or session variable and sending the report to the solution provider.

Such an embodiment offers several advantages over the prior art. The universal tag on the web site need not be touched after initial set-up, since the program code is hosted in the tracking database. In addition, although many solution providers may be associated to the universal tag, only those that desire or require data from the particular access event will receive a report. Each solution receives the data it desires, based on the tracking code on record in the database. A web analytics system receives a report with the data it requires, while an affiliate marketing system may receive a report with more, less or different data than the web analytics system.

Additional advantages and features of the invention will be set forth in part in the description which follows, and in part, will become apparent to those skilled in the art upon examination of the following or may be learned by practice of the embodiments and features disclosed.

### BRIEF DESCRIPTION OF THE DRAWINGS

FIG. 1 illustrates in context, an e-commerce application and web services system with exemplary ancillary marketing solutions.

FIG. 2 illustrates a current, typical e-commerce pages tagged for tracking by various exemplary providers.

FIG. 3 illustrates the current, typical tagging of individual pages with individual tags to service each of the marketing providers.

FIG. 4 illustrates the backend tracking database accessed in order to determine the appropriate tag code to execute when a user accesses a web page.

FIG. 5 is a flow chart describing the execution of the universal tracking agent system and method.

FIG. 6 illustrates the execution of the universal tracking agent system and method in the context of an email marketing campaign.

### DETAILED DESCRIPTION

While the majority of the terms used in this disclosure are well known to those skilled in the art, the following terms have specific meanings when discussing a preferred embodiment of a universal tracking system and method:

User: a user is a person accessing a web site or web page using a browser on a local or client computer. Also referred to as a site visitor.
Access event: an access event occurs when the user enters a tagged web site. An event may be triggered by a click on a link in an e-mail, a paid search link, or any other event that leads the user to the tagged web site.
Sniffer: a sniffer is web page program code that, when fired, executes a program to read data from a local computer (e.g., a cookie or session variable set on a user computer browser). The sniffer code is hosted outside of the web page, preferably the sniffer code is stored in the tracking database.
Solution: web analytics systems, optimization systems, and the various marketing tools to which a web merchant subscribes in order to enhance the value of its site to users. In this sense, solutions collect and analyze data for the purpose of aiding the merchant in its goal to provide the best experience for the user. Solutions may also be referred to as systems operated by third-party providers. Third-party providers in this disclosure refer to any system outside of a universal tracking system which may be another service also hosted within a single e-commerce system or by a provider that hosts one or more e-commerce related services. For example, a universal tracking agent may be used for e-commerce system merchandising.
Tracking code: tracking code is computer code stored in the database and is associated with a solution provider and may be associated with a particular web page. When executed, the program code collects behavioral or transactional data resulting from a user's web site activities.

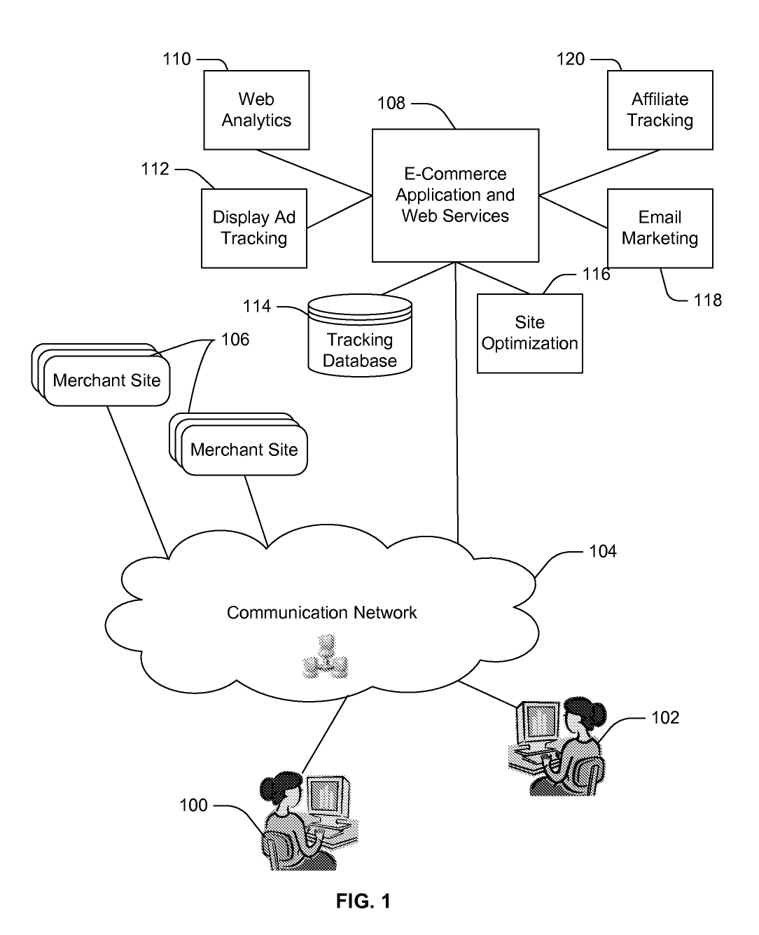

A preferred embodiment of a universal tracking system contemplates an e-commerce application server connected via the internet and providing its services to one or more internet merchants whose web-sites may be accessed by Internet users. An exemplary system is illustrated in FIG. 1. An e-commerce application server or computing device 108 may host merchant web sites and/or online shopping tools and web services such as product catalogs and search tools, shopping carts, and software modules executing program code to perform or interface with fraud, payment, fulfillment, shipping and secure transaction processing, either on the same server or distributed over multiple computer devices. The system might also include any type of merchant web site(s) 106 with items to sell or distribute, possibly hosted on a web server, and operatively connected to an e-commerce system 108 via the Internet 104. The exemplary data processing system includes various computers or computing devices, including end user machines 100, 102, web site servers 106, an e-commerce system or platform and web services 108 hosted on one or more servers (computing devices), web analytics 110 and site optimization modules 116 hosted on servers, that may be used to optimize a user's experience on the web site, and any number of various marketing solution modules (e.g. display advertising 112, affiliate tracking 120, email tracking 118) that may be hosted on the same or different computing devices. Each computer or computing device is connected with a network 104 such as the Internet or other type of data network.

A computer or computing device typically includes a memory, a secondary storage device, a processor (central processing unit, or CPU), an input device, a display device, and an output device. The memory may include random access memory (RAM) or similar types of memory. Software applications, stored in the memory or secondary storage for execution by a processor are operatively configured to perform the operations of the exemplary system. The software applications may correspond with a single module or any number of modules which are program code or instructions for controlling a computer processor to perform a particular method. The modules preferably implement the features or operations of the system. The modules may also be implemented using program products or a combination of software and specialized hardware components. In addition, the modules may be executed on multiple processors for processing a large number of transactions, if necessary or desired.

The secondary storage device may include a hard disk drive, floppy disk drive, CD-ROM drive, DVD-ROM drive, or other types of non-volatile data storage, and it may correspond with the various modules shown in the figures. The processor may execute the software applications or programs either stored in memory or secondary storage or received from the Internet or other network. The input device may include any device for entering information into computer, such as a keyboard, cursor-control device, or touch-screen. The display device may include any type of device for presenting visual information such as, for example, a computer monitor or flat-screen display. The output device may include any type of device for presenting a hard copy of information, such as a printer, and other types of output devices include speakers or any device for providing information in audio form.

Although the computer or computing device has been described with various components, one skilled in the art will appreciate that such a computer or computing device can contain additional or different components. In addition, although aspects of an implementation consistent with the present embodiments and features are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or ROM. One skilled in the art would recognize that computing devices may be local, client or server computers. Local/client computers (e.g. 100 and 102) are understood by those skilled in the art to be those computers used by end users to access information, for example, from a server over a network such as the Internet 104. Servers are understood to be those computing devices that provide services to other machines, and may be (but are not required to be) dedicated to hosting applications or content to be accessed by any number of local/client computers.

In addition to the modules and services described above, an e-commerce system 108 may be operatively connected to any number of third-party solution provider systems, such as web analytics modules 110, site optimization modules 116 and marketing modules 112,118, 120. These and similar modules allow web merchants to collect data related to what is purchased or viewed on their sites as well as associated sites, and test various web page configurations and content in order to determine the combination that provides the greatest lift in sales for a particular marketing campaign or an optimal experience for the site visitor. The description of such a system and modules is intended to be illustrative and in no way limiting. One skilled in the art would appreciate that other modules and functions may be provided, depending on business or technical requirements.

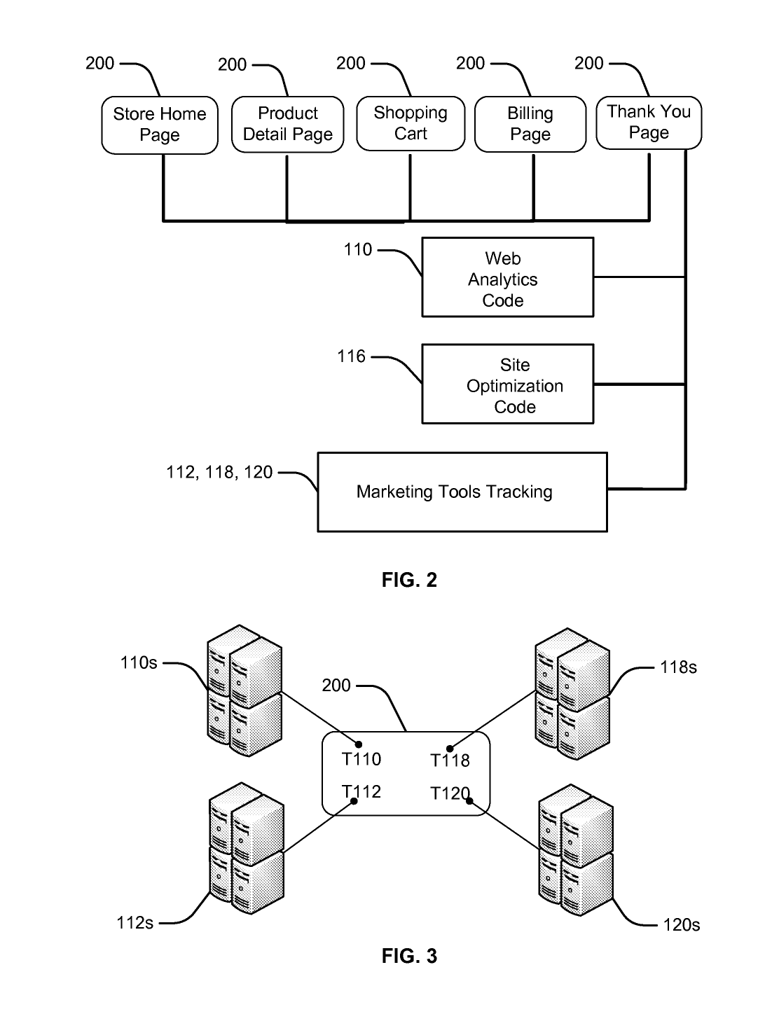

A typical web page tagging scheme as is known in the prior art is illustrated in FIGS. 2 and 3. Web pages 200 are tagged with identifiers for web analytics 110 (T110) and for various marketing tools (T112, T118, T120) such as display advertising tracking 112, E-mail marketing tracking 118 and affiliate tracking 120. When an access event occurs (e.g. the user accesses the site), the tag fires, and sends a report or log file, based on code provided by those systems, to the tag owner's server 112s, 118s, 120s, as shown in FIG. 3.

A drawback to this type of system is that the occurrence of an access event may trigger the firing of all pixel tags on a page, whether or not the appropriate conditions are met. For example, if affiliate tracking, paid search and e-mail marketing campaigns all tag the thank you page of a web site, all tags will fire on occurrence of the event, regardless of the means of access of the user. An event of a user completing a sales transaction after having entered the site on a paid search may send a record to affiliate tracking and e-mail marketing data collection solutions as well as the paid search solution. Further, not all systems are looking for the same data. A need exists for a system and method that enables the creation of and sending of individualized reports only to those marketing solutions that require a record under specific conditions.

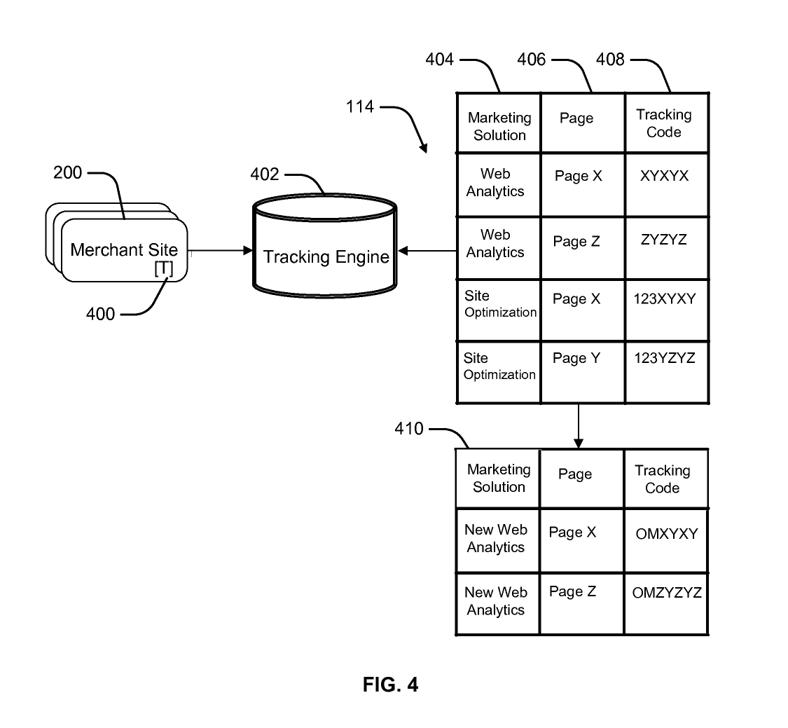

FIG. 4 illustrates a preferred embodiment of a universal tracking agent system and method that satisfies these needs and provides solutions to other problems as described below. A preferred embodiment of a universal tracking agent system and method utilizes a single universal tag 400 with a universal tracking “sniffer” agent, or program code, to determine which of the many tracking codes (which would have previously been individual pixels installed on the page, as shown in FIG. 3) should be activated, based on the cookie or session variable set by accessing the web page. A tracking database 114 maintains a record for each tag owner (marketing solution) 404 along with the pages on which it should fire 406 (execute the program code in a processor on the local/client computer) and its tracking code 408. When the user accesses the page and the universal tag fires by executing the sniffer code. This sniffer code may be stored in the tracking database and associated with the web page or the sniffer code may be contained within the web page itself. The sniffer code (i.e., the executing program code) reads the data from a local computer (e.g., a cookie or session variable set on a user computer browser) to determine the data it is looking for, and sends the cookie or session variable information to the tracking engine 402. The tracking engine 402 consults the database to determine which tracking code(s) 408 should be executed. Any changes or additions that need to be made to facilitate tracking are made to the database; the web page does not need to be modified in any way. For example, records 410 illustrate a change in the web analytics provider servicing the merchant. In this scenario, the records for the original web analytics provider have been disabled, and the records for the new analytics provider have been enabled 410. Similarly, a tracking code for an existing code for an existing third party service provider may be modified in the database and accessed by the tracking system without changes to the website. Similarly, adding additional third party service providers or tracking codes for additional third party service providers would be accomplished by adding additional database records.

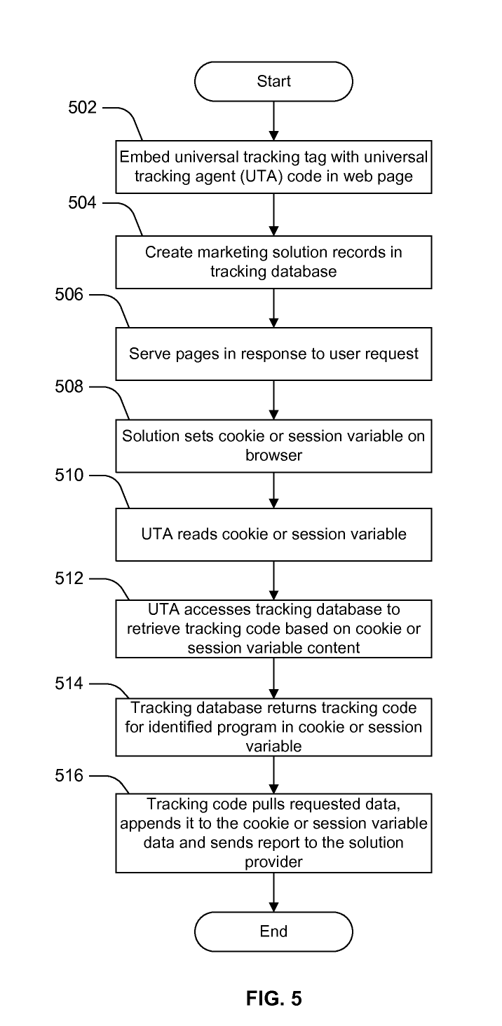

A preferred embodiment of a UTA process is further described in the flow chart of FIG. 5. The universal tracking tag is embedded in all applicable web pages 502. A record is created in the tracking database for each of the marketing solutions 504. The record includes the name of the solution, the pages that the solution tracks, and the JavaScript tracking code. The page is served to the user in response to a click or other request 506. The marketing solution sets a cookie or session variable on the requesting browser 508. The “sniffer” agent, or universal tracking agent (UTA), reads the cookie or session variable to determine which solution(s) require data 510; the database engine finds the record for the marketing solution in the database 512, and executes the tracking code associated with the marketing solution 514. The tracking code pulls the requested data, appends it to the cookie or session variable data, and sends the report to the marketing solution server 516.

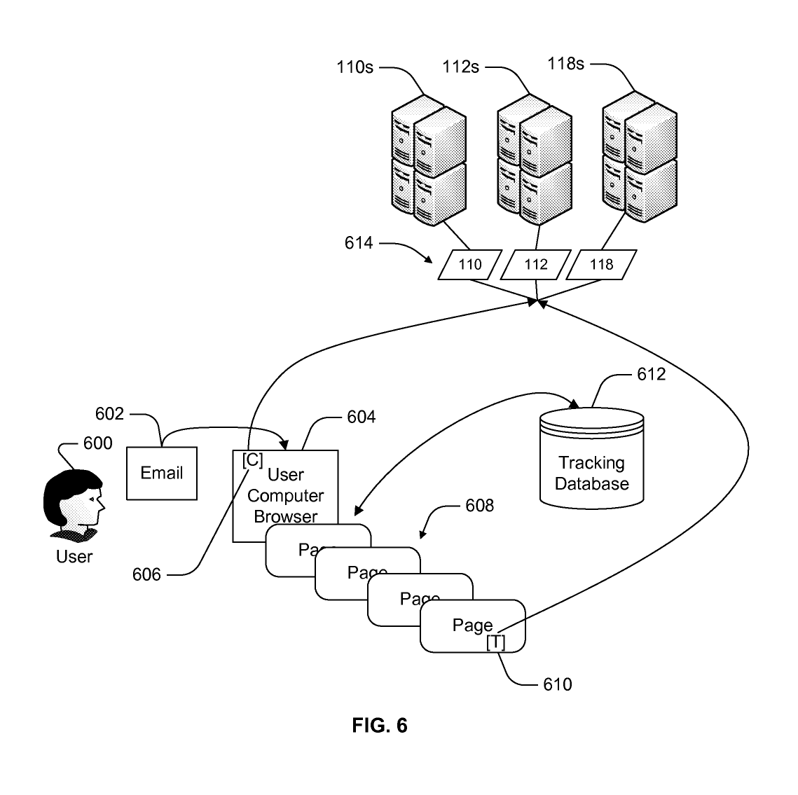

FIG. 6 illustrates a universal tracking agent system and method in the context of an e-mail marketing campaign. A user 600 receives an email 602 as part of a marketing campaign. The user clicks on the offer in the email, which opens the user's browser 604 and/or redirects the user to the tagged website 608. When the site is accessed, a cookie or session variable 606 is set on the user's browser. A single universal tag 610 has been placed on each page in place of the web analytics 110, site optimization 112 and one or more marketing solution system tags, including an email marketing 118 system tag. The UTA sniffer code collects data 606 from the local computer (e.g., a cookie or session variable set on a user computer browser) and reaches out to a backend database 612 in order to render the necessary tracking code(s). In a scenario where web analytics and site optimization are always collecting data, the codes that would be returned might be web analytics, site optimization and the email marketing system code for whichever pages are tagged, while records for paid search, affiliate marketing and others that are also associated with the universal tag are ignored. The tracking codes execute, pulling data 606 from a local computer (e.g., a cookie or session variable set on a user computer browser) and the tracking code from the database 612, and sending a report 614 to the appropriate system servers. Each report meets the specific requirements of each of the receiving systems (110, 112 and 118 represented by servers 110s, 112s and 118) because each system's specific tracking code has been executed.

It is to be understood that even though numerous characteristics and advantages of various embodiments of the present disclosure have been set forth in the foregoing description, together with details of the structure and function of various embodiments of the disclosure, this disclosure is illustrative only, and changes may be made in detail, especially in matters of structure and arrangement of parts within the principles of the present disclosure to the full extent indicated by the broad general meaning of the terms in which the appended claims are expressed. For example, the particular elements may vary depending on the particular provider systems used, such that different communication protocols may be organized or designed differently while maintaining substantially the same functionality and without departing from the scope and spirit of the present embodiments and features disclosed.

What is claimed is:

1. A web-based universal tracking agent system for use on a network including a local computer with a processor and a memory, comprising:
a single, universal tag on merchant web pages in a commerce system containing program code which when executed by a processor on a local computer causes the local computer to collect user behavior tracking data and analysis when merchant web pages are accessed by the browser;
a tracking system receives the user behavior tracking data and accesses a tracking code from a database stored on a server based on receipt of the user behavior tracking data, the database comprising records describing a third party service provider subscribed to by the merchant that operates the merchant web pages, the tracking code is executed by the processor on the local computer to: (i) collect additional user behavior data specified by the third party service provider, (ii) generate an individualized report containing the user behavior tracking data and the additional user behavior data, and (iii) send the individualized report to the third party service provider.

2. The universal tracking agent system of claim 1 wherein the database record data for the third party service provider is changed to a second third party service provider such that after the database record data is changed the tracking system accesses another tracking code from the database associated with second third party service provider, collects additional user behavior data specified by the second third party service provider, generates an individualized report containing the user behavior tracking data and the additional user behavior data, and sends the individualized report to the second third party service provider.

3. The universal tracking agent system of claim 1 wherein the database record data for the third party service provider is changed to modify the tracking code such that after the database record data is changed the tracking system accesses the modified tracking code from the database associated with third party service provider and collects additional user behavior data specified by the second third party service provider in the modified tracking code.

4. The universal tracking agent system of claim 1 wherein the tracking system receives the user behavior tracking data and accesses a plurality of tracking codes from a database stored on a server based on receipt of the user behavior tracking data, the database comprising records describing a plurality of third party service providers subscribed to by the merchant that operates the merchant web pages, each tracking code is executed by the processor on the local computer to: (i) collect additional user behavior data specified by each third party service provider, (ii) generate an individualized report containing the user behavior tracking data and the additional user behavior data, and (iii) send the individualized report to each third party service provider.

5. A web-based universal tracking agent method for use on a network including a local computer with a processor and a memory, the tracking agent method comprising steps of:
collecting user behavior tracking data and analysis when merchant web pages are accessed by the browser by a processor on a local computer executing program code contained in a single, universal tag on merchant web pages in a commerce system;
receiving the user behavior tracking data at a tracking system;
accessing, at the tracking system, a tracking code from a database stored on a server based on receipt of the user behavior tracking data, the database comprising records describing a third party service provider subscribed to by the merchant that operates the merchant web pages,
executing the tracking code by the processor on the local computer to: (i) collect additional user behavior data specified by the third party service provider, (ii) generate an individualized report containing the user behavior tracking data and the additional user behavior data, and (iii) send the individualized report to the third party service provider.

6. The universal tracking agent method of claim 5 further comprising a step of changing the database record data for the third party service provider to a second third party service provider such that, after the database record data is changed, the accessing step comprises accessing another tracking code from the database associated with second third party service provider, and the executing the tracking code step comprises collecting additional user behavior data specified by the second third party service provider, generating an individualized report containing the user behavior tracking data and the additional user behavior data, and sending the individualized report to the second third party service provider.

7. The universal tracking agent method of claim 5 further comprising a step of changing the database record data for the third party service provider to modify the tracking code such that, after the database record data is changed, the accessing step comprises accessing the modified tracking code from the database associated with third party service provider and the executing the tracking code step comprises collecting additional user behavior data specified by the second third party service provider in the modified tracking code.

8. The universal tracking agent method of claim 5 wherein:
the accessing step comprises accessing a plurality of tracking codes from a database stored on a server based on receipt of the user behavior tracking data, the database comprising records describing a plurality of third party service providers subscribed to by the merchant that operates the merchant web pages,
the executing step comprises executing each tracking code by the processor on the local computer to: (i) collect additional user behavior data specified by each third party service provider, (ii) generate an individualized report containing the user behavior tracking data and the additional user behavior data, and (iii) send the individualized report to each third party service provider.
